(19) United States
(12) Patent Application Publication
(10) Pub. No.: US 2002/0046082 A1
(43) Pub. Date: Apr. 18, 2002

(54) PROCESS, SYSTEM AND COMPUTER READABLE MEDIUM FOR IN-STORE PRINTING OF RAINCHECKS FOR DISCOUNT COUPONS AND/OR OTHER PURCHASING INCENTIVES IN A RETAIL STORE

(76) Inventor: PHILLIP WHITE, CLIFTON BRISTOL (GB)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/317,110

(22) Filed: May 24, 1999

(51) Int. Cl. G06F 17/60

(52) U.S. Cl. 705/14; 705/16

(57) ABSTRACT

A system, process and computer readable medium for providing in-store printing of rainchecks for purchasing incentives associated with items subject to rainchecks, including an incentive processor for storing a plurality of purchasing incentives corresponding to a plurality of item identifiers for items subject to rainchecks; at least one incentive printer; a incentive processor bus coupling the incentive processor to the at least one incentive printer; a point-of-sale (POS) controller; at least one cash register; and a POS bus coupling the POS controller, the at least one cash register, and the incentive processor. A respective cash register of the at least one cash register is configured to receive data defining an item identifier for an item that is subject to a raincheck. One of the POS controller and the respective cash register is configured to transmit the data defining the item identifier for the item that is subject to the raincheck over the POS bus to the incentive processor. The incentive processor is configured to generate raincheck information including at least one purchasing incentive in response to receipt of the data defining the item identifier for the item subject to the raincheck, the plurality purchasing incentives, and the plurality of item identifiers. The incentive processor is configured to transmit the raincheck information to a respective incentive printer of the at least one incentive printer over the incentive processor bus. The respective incentive printer is configured to print a raincheck including the at least one purchasing incentive in response to receipt of the raincheck information received from the incentive processor.

### CROSS REFERENCES TO RELATED APPLICATIONS

The present invention is related to commonly owned U.S. Pat. Nos. 4,723,212; 4,910,672; 5,173,851; and 5,612,868, U.S. patent application Ser. No. 08/663,680, filed on Jun. 14, 1996, and U.S. patent application Attorney Docket Number 7791-0050-25, filed on Jan. 6, 1999, all of which are incorporated herein by reference.

### BACKGROUND OF THE INVENTION

1. Field of the Invention

This invention relates generally to interconnected computer systems and, more particularly, to computer systems used in a retail store environment.

2. Discussion of Background

FIG. 1 shows a conventional retail store environment, including a store point-of-sale (POS) controller 10, a store point-of-sale loop (POS loop) 12, and multiple cash registers or point-of-sale terminals 14, two of which are shown. The store POS controller 10 communicates with the cash registers 14 through the store POS loop 12, which is a data bus that extends through the store from one cash register 14 to the next and to which all the cash 20 registers 14 and the store POS controller 10 are connected. The store POS controller 10 has associated database files (not shown) for storing data pertaining to store activities, such as an item record file defining the items available for sale in the store.

The inventors have recognized a difficulty with the configuration shown in FIG. 1 which is that this configuration does not support supplemental functions, such as in-store printing of discount coupons and/or other purchasing incentives, reading and processing coupons brought to the store by customers, and reading other coded items at the point-of-sale, such as bank cards, customer loyalty cards, such as frequent shopper cards, credit cards, and checks, etc. In addition, when a particular item having discount coupons and/or other purchasing incentives associated therewith is not in stock, this configuration does not support in-store printing of a “raincheck.” A raincheck allows the customer to exercise the discount coupons and/or other purchasing incentives at a time in the future when the item is in stock.

### SUMMARY OF THE INVENTION

Accordingly, one object of this invention is to provide a novel process, system and computer readable medium for providing in-store printing of rainchecks for discount coupons and/or other purchasing incentives.

The above and other objects are achieved according to the present invention by providing a new and improved system, process and computer readable medium for providing in-store printing of rainchecks for purchasing incentives associated with items subject to rainchecks, including an incentive processor for storing a plurality of purchasing incentives corresponding to a plurality of item identifiers for items subject to rainchecks; at least one incentive printer; a incentive processor bus coupling the incentive processor to the at least one incentive printer; a point-of-sale (POS) controller; at least one cash register; and a POS bus coupling the POS controller, the at least one cash register, and the incentive processor. A respective cash register of the at least one cash register is configured to receive data defining an item identifier for an item that is subject to a raincheck. One of the POS controller and the respective cash register is configured to transmit the data defining the item identifier for the item that is subject to the raincheck over the POS bus to the incentive processor. The incentive processor is configured to generate raincheck information including at least one purchasing incentive in response to receipt of the data defining the item identifier for the item subject to the raincheck, the plurality purchasing incentives, and the plurality of item identifiers. The incentive processor is configured to transmit the raincheck information to a respective incentive printer of the at least one incentive printer over the incentive processor bus. The respective incentive printer is configured to print a raincheck including the at least one purchasing incentive in response to receipt of the raincheck information received from the incentive processor.

### BRIEF DESCRIPTION OF THE DRAWINGS

A more complete appreciation of the invention and many of the attendant advantages thereof will be readily obtained as the same becomes better understood by reference to the following detailed descriptions when considered in connection with the accompanying drawings, wherein:

FIG. 1 is block diagram of a conventional computer interconnection architecture of a retail store environment;

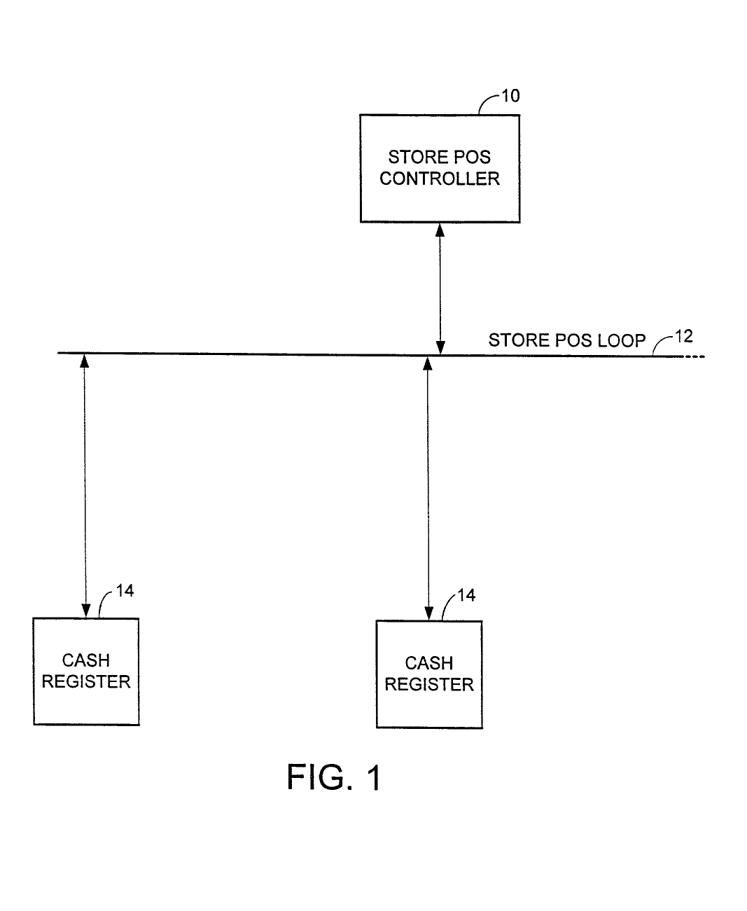

FIG. 2 is a block diagram of a computer interconnection architecture of a retail store environment of FIG. 1, supplemented with additional components to handle various additional functions at a point-of-sale (POS);

FIG. 3 is a top level flow chart illustrating a process for generating rainchecks for discount coupons and/or other purchasing incentives according to the present invention.

FIG. 4 is an illustration of a raincheck list used for in-store printing of rainchecks for discount coupons and/or other purchasing incentives according to the present invention; and

FIG. 5 is a detailed flow chart illustrating a process for in-store printing of rainchecks for discount coupons and/or other purchasing incentives according to the present invention.

### DESCRIPTION OF THE PREFERRED EMBODIMENTS

Point-of-sale (POS) computer systems in stores have been supplemented with additional components to handle such functions as in-store printing of discount coupons and/or other purchasing incentives, reading and processing coupons brought to the store by customers, and reading other coded items at the point-of-sale, such as bank cards, customer loyalty cards, such as frequent shopper cards, credit cards, and checks, etc. For example, commonly owned U.S. Pat. Nos. 4,723,212; 4,910,672; 5,173,851; and U.S. Pat. No. 5,612,868, U.S. patent application Ser. No. 08/663,680, filed on Jun. 14, 1996, and U.S. patent application Attorney Docket Number 7791-0050-25, filed on Jan. 6, 1999, disclose systems for generating discount coupons in response to various sales transaction events detected at the point-of-sale.

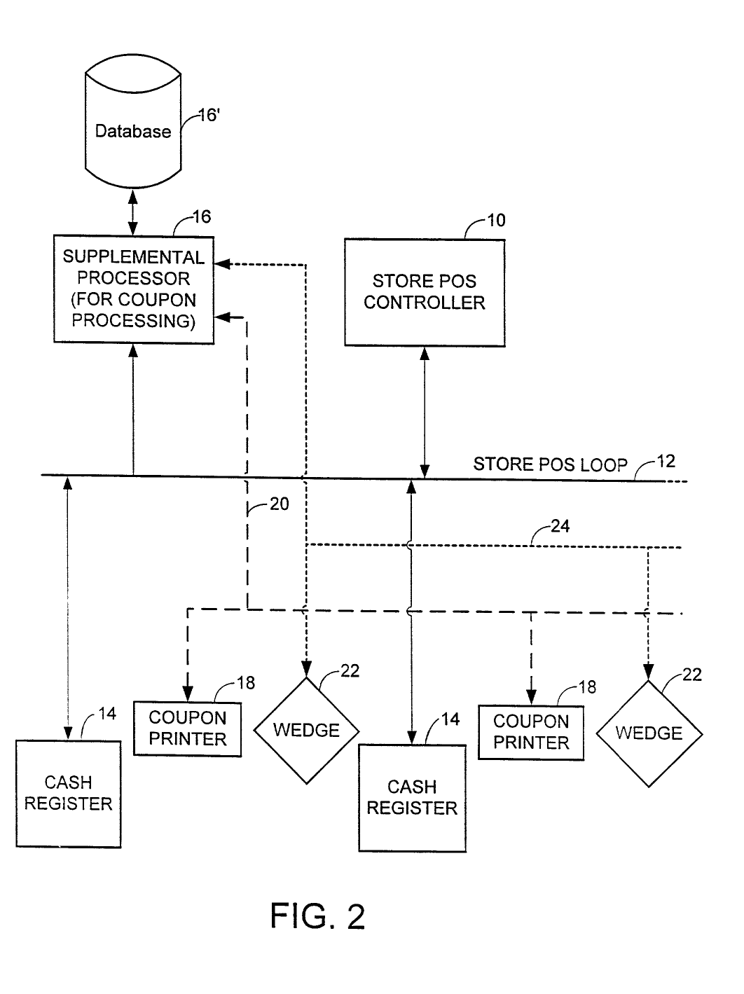

Referring now to the drawings, wherein like reference numerals designate identical or corresponding parts throughout the several views, and more particularly to FIG. 2 thereof, there is illustrated a computer system architecture intended for use in a retail store environment, and particularly for use in applications that supplement the normal functions of a point-of-sale computer system.

FIG. 2 shows relevant portions of a store point-of-sale system, including a store point-of-sale (POS) controller, indicated by reference numeral 10, a store point-of-sale loop (POS loop) 12, and multiple cash registers 14, two of which are shown. The store POS controller 10 communicates with the cash registers 14 through the store POS loop 12, which is a data bus that extends through the store from one cash register to the next. The store POS controller 10 has associated database files (not shown) for storing data pertaining to store activities, such as an item record file defining the items available for sale in the store. A supplemental processor 16 is provided and performs supplemental processing functions, such as in-store generation of discount coupons and other purchase incentives, etc. The supplemental processor 16 is connected to the store POS loop 12 and can monitor POS operations taking place at the various cash registers 14. The supplemental processor 16 is coupled to a database 16′ for storing consumers' shopping history which may be used in selecting discount coupons and other purchase incentives, etc. to be generated. Each cash register 14 in such a system has an associated coupon printer 18. However, it will be appreciated that each coupon printer 18 or cash register 14 could include a “dual station” printer function for printing both discount coupons and receipts. When a consumer purchases certain designated items and presents them for purchase at the cash register 14, the supplemental processor 16 may generate discount coupons conditioned on the items purchased and other factors, such as the consumer's shopping history stored in database 16′ and associated with a personal-identification-number (PIN) of the consumer. Thus, the supplemental processor 16 is connected to each of the coupon printers 18, as shown by broken lines 20.

The supplemental processor 16 may also be connected to other peripheral devices associated with each cash register 14. For example, each cash register 14 may have an associated wedge 22. A wedge is a data input device that decodes or reads data, such as bar code data or data from magnetically encoded cards, such as bank cards, customer loyalty cards, such as frequent shopper cards, credit cards, etc. The wedge 22 communicates the decoded information through a keyboard port on a computer associated with each cash register 14. Typically, the wedge device 22 plugs into the computer keyboard port, and the keyboard plugs into the wedge. In some POS functions, a consumer's card, such as bank card, customer loyalty card, such as frequent shopper card, credit card, etc., having a unique consumer identifier, such as a personal-identification-number (PIN) encoded therein, is scanned in the wedge device 22 and the information is used by the supplemental processor 16 when recording purchase transactions to the consumer's shopping history associated with the PIN in the database 16′. The wedges 22 are connected to the supplemental processor 16 through another set of lines, indicated by the broken lines 24.

In addition, the configuration shown in FIG. 2 may be supplemented to support in-store printing of rainchecks for discount coupons and/or other purchasing incentives for items that are not in stock. It is noted that providing in-store printing of rainchecks for the discount coupons and/or other purchasing incentives for items that are not currently in stock, allows consumers to receive the benefit of the discount coupons and/or other purchasing incentives when the items are later in stock.

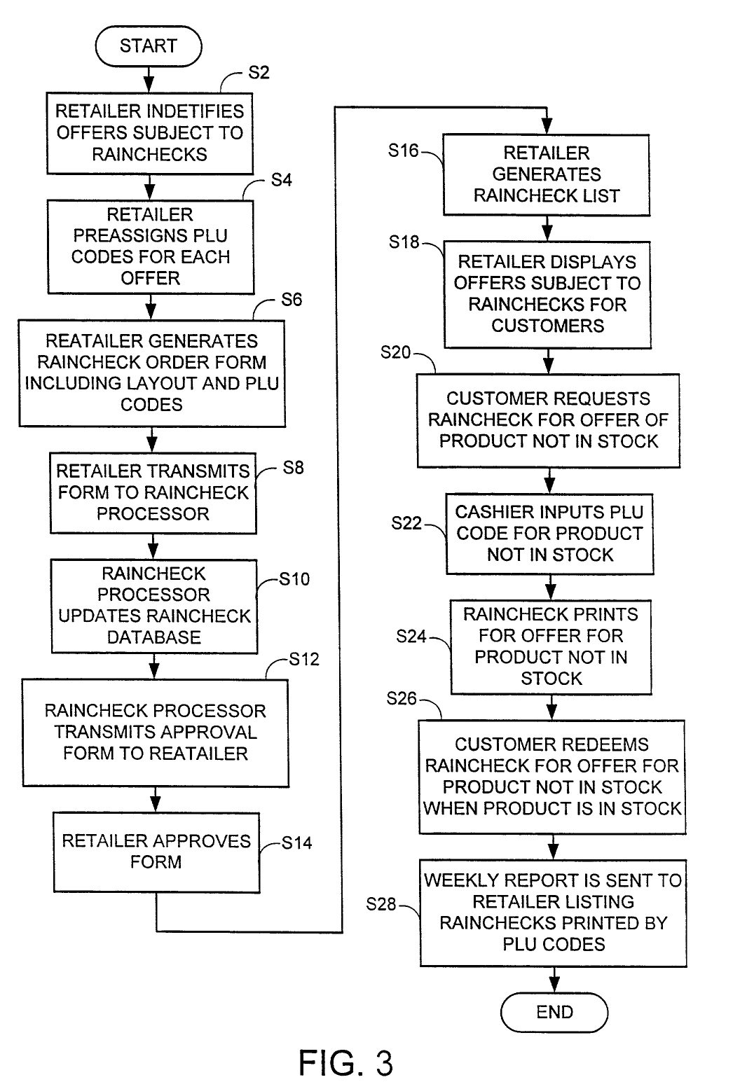

FIG. 3 is a top level flow chart illustrating a process for generating rainchecks for discount coupons and/or other purchasing incentives according to the present invention. In FIG. 3, at step S2 a retailer identifies offers (e.g., discount coupons and/or other purchasing incentives) for products that are to be guaranteed with rainchecks if the products are out of stock. At step S4, the retailer assigns pre-set price look-up (PLU) codes for each identified offer. The retailer, at step S6, generates a raincheck order form, for example, using an Excel™ spreadsheet, etc., and including the raincheck layout and the assigned PLU codes.

At step S8, the retailer transmits the form, for example, via email, etc., to a raincheck processing site having access to databases 16′ at the retail store. The raincheck processing site then updates the database 16′ with the raincheck information via the supplemental processor 16 at step S10. At step S12, the raincheck processing site transmits an approval form, for example, via email, etc., to the retailer which the retailer signs and returns to the raincheck processing site, for example, via email, etc., at step S7.

The retailer or raincheck processing site, at step S16, then generates a raincheck list to be used by the cashiers and including preassigned price look-up (PLU) codes for products subject to rainchecks. At step S18, the retailer displays for customers the offers for the products subject to rainchecks. Then at step S20, when a customer request a raincheck for a product not in stock, at step S22, the cashier enters the corresponding PLU code for the product not in stock at the cash register 14. At step S24, the raincheck is printed on the coupon printer 18 and is handed to the customer and a dated record of the printing of the raincheck and corresponding PLU code for the product not in stock is stored in the database 16′ as a printed raincheck list.

At step S26, the customer redeems the raincheck for the product not in stock when the product is later in stock. Weekly reports listing rainchecks printed according to PLU codes are generated based on the printed raincheck list stored in the database 16′.

According to the present invention, rainchecks are printed at the coupon printers 18 of a retail store based on preassigned price look-up (PLU) codes for items subject to rainchecks. The PLU codes for items subject to rainchecks and the discount coupons and/or other purchasing incentives associated therewith (i.e., offers) are stored in the database 16′. A raincheck list is printed and provided at each cash register 14 and includes the PLU codes and descriptions for the items subject to rainchecks. When a cashier enters a PLU code for an item not in stock from the raincheck list at a cash register 14, this information is transmitted to the supplemental processor 16. The supplemental processor 16 then generates raincheck information based on the PLU code for the item not in stock, and the discount coupons and/or other purchasing incentives associated therewith that are stored in the database 16′. The raincheck information is then transmitted to the a coupon printer 18 which prints the raincheck based on the received raincheck information. It should be noted that the printed raincheck may be in the form of (i) a token enabling a customer to purchase an item not in stock when the item is in stock and at the price when the item was not in stock, and/or (ii) a discount coupon enabling a customer to purchase an item not in stock when the item is in stock and at a discounted price.

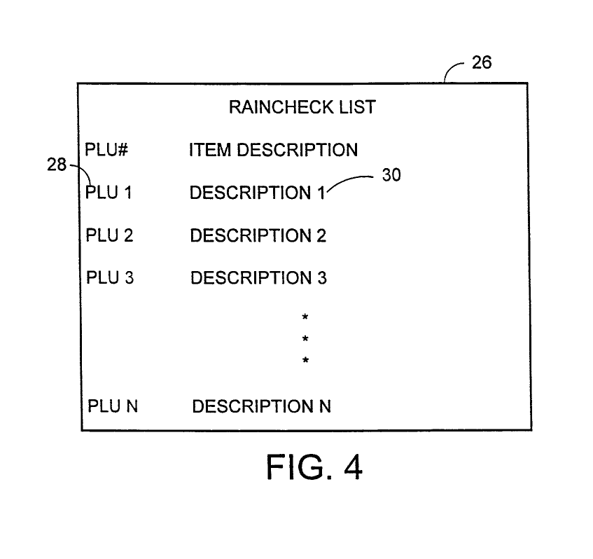

FIG. 4 is an illustration of a raincheck list 26 used for in-store printing at a retail store of rainchecks for discount coupons and/or other purchasing incentives associated with items subject to rainchecks. In FIG. 4, the raincheck list 26 includes price look-up (PLU) codes 28 and corresponding descriptions 30 for the items subject to rainchecks. When cashiers enter PLU codes from the raincheck list 26 for items subject to rainchecks at the cash registers 14, rainchecks for discount coupons and/or other purchasing incentives associated with the items subject to rainchecks are automatically printed at the coupon printers 18.

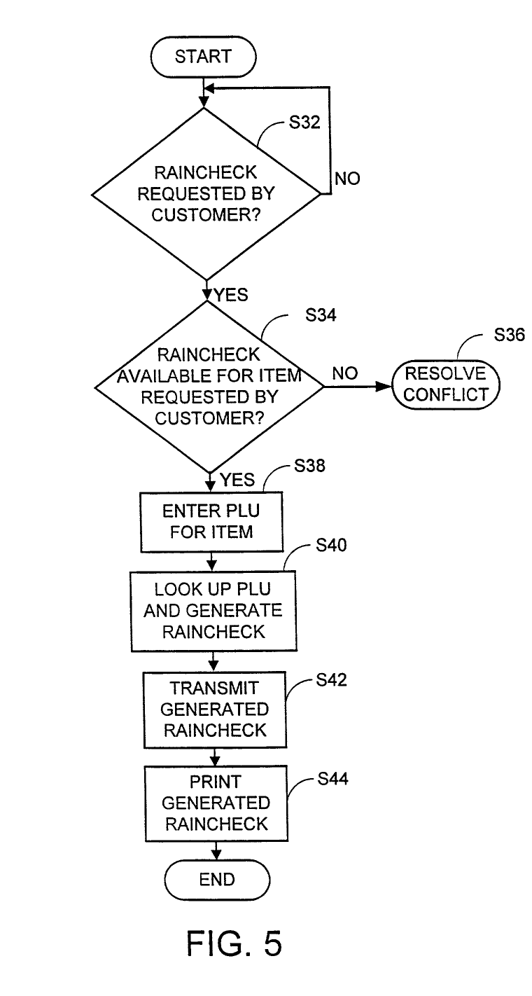

The process for providing in-store printing of rainchecks for discount coupons and/or other purchasing incentives for items that are not currently in stock will now be explained with reference to the flow chart shown in FIG. 5. In FIG. 5, at step S32, a customer requests a raincheck for discount coupons and/or other purchasing incentives associated with an item that is currently not in stock in a retail store. In step S34, a determination is made as to whether or not there is a raincheck available for the discount coupons and/or other purchasing incentives associated with the item, for example, by using the raincheck list 26 as discussed with respect to FIG. 4. If no raincheck is available for the item, at step S36 the conflict is resolved, for example, by having store personnel determine if there is an error in the raincheck list 26 or if no discount coupons and/or other purchasing incentives are associated with the item. If there is an error in the raincheck list 26, the customer receives a raincheck that is manually generated by the store personnel and the raincheck list 26 and associated files in the database 16′ are updated.

If, at step S34, it is determined that a raincheck is available for the discount coupons and/or other purchasing incentives associated with the item, at step S38 a price look-up (PLU) code is entered for the item using the raincheck list 26 at the cash register 14 and transmitted to the supplemental processor 16 over the store POS loop 12. At step S40, the supplemental processor 16 looks up the PLU code for the item and generates raincheck information for the discount coupons and/or other purchasing incentives associated with the item. The supplemental processor 16 then transmits the raincheck information to the coupon printer 18 at step S42.

At step S44, the coupon printer 18 prints the raincheck for the discount coupons and/or other purchasing incentives associated with the item based on the received raincheck information and a dated record of the printing of the raincheck and corresponding PLU code for the item is stored in the database 16′ as a printed raincheck list by the supplemental processor 16. It is noted that the raincheck for the discount coupons and/or other purchasing incentives may include the original discount coupons and/or other purchasing incentives associated with the item and/or additional discount coupons and/or other purchasing incentives for the item based on the fact that a raincheck had to be issued for the item. In this way, the additional discount coupons and/or other purchasing incentives for the item may be generated to help to make up for any inconvenience to the customer for the item being out of stock. Accordingly, it should be noted that the printed raincheck may be in the form of (i) a token enabling a customer to purchase an item not in stock when the item is in stock and at the price when the item was not in stock, and/or (ii) a discount coupon enabling a customer to purchase an item not in stock when the item is in stock and at a discounted price.

It will be appreciated from the foregoing that the present invention represents a significant advance in the field of retail store computer systems. In particular, the invention provides in-store printing of rainchecks for discount coupons and/or other purchasing incentives associated with an item that is currently not in stock in a retail store.

The mechanisms and processes set forth in the present description may be implemented using a conventional general purpose microprocessor (e.g., the supplemental processor 16 and the store POS controller 10) programmed according to the teachings in the present specification (e.g., FIGS. 3 and 5), as will be appreciated to those skilled in the relevant art(s). Appropriate software coding can readily be prepared by skilled programmers based on the teachings of the present disclosure, as will also be apparent to those skilled in the relevant art(s). However, as will be readily apparent to those skilled in the art, this invention may also be implemented by the preparation of application-specific integrated circuits or by interconnecting an appropriate network of conventional component circuits.

The present invention thus also includes a computer-based product which may be hosted on a storage medium and include instructions which can be used to program a microprocessor to perform processes in accordance with the present invention. This storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by letters patent of the United States is:

1. A system for providing in-store printing of rainchecks for purchasing incentives associated with items subject to rainchecks, comprising:
an incentive processor for storing a plurality of purchasing incentives corresponding to a plurality of item identifiers for items subject to rainchecks;
at least one incentive printer;
a incentive processor bus coupling said incentive processor to said at least one incentive printer;
a point-of-sale (POS) controller;
at least one cash register; and
a POS bus coupling said POS controller, said at least one cash register, and said incentive processor;
wherein a respective cash register of said at least one cash register is configured to receive data defining an item identifier for an item that is subject to a raincheck;
one of said POS controller and said respective cash register is configured to transmit said data defining said item identifier for said item that is subject to said raincheck over said POS bus to said incentive processor;
said incentive processor is configured to generate raincheck information including at least one purchasing incentive in response to receipt of said data defining said item identifier for said item subject to said raincheck, said plurality purchasing incentives, and said plurality of item identifiers;
said incentive processor is configured to transmit said raincheck information to a respective incentive printer of said at least one incentive printer over said incentive processor bus; and
said respective incentive printer is configured to print a raincheck including said at least one purchasing incentive in response to receipt of said raincheck information received from said incentive processor.

2. The system of claim 1, further comprising:
a retailer site configured to identify said plurality of purchasing incentives corresponding to said plurality of item identifiers; and
an incentive processing site;
wherein said retailer site configured to transmit said plurality of purchasing incentives corresponding to said plurality of item identifiers to said incentive processing site;
said incentive processing site is configured to receive said plurality of purchasing incentives corresponding to said plurality of item identifiers from said retailer site; and
said incentive processing site is configured to store said plurality of purchasing incentives corresponding to said plurality of item identifiers via said incentive processor.

3. The system of claim 2, wherein one of said retailer site and said incentive processing site is configured to generate a raincheck list including a description of items corresponding to said plurality of item identifiers along with said plurality of item identifiers; and
said respective cash register of said at least one cash register is configured to receive said data defining said item identifier for an item that is subject to a raincheck based on said raincheck list.

4. The system of claim 2, wherein said incentive processor is configured to store a printed raincheck list comprising a list of when rainchecks were printed and item identifiers corresponding thereto; and
said incentive processing site is configured to generate a weekly report of printed rainchecks and item identifiers corresponding thereto based on said printed raincheck list.

5. The system of claim 1, wherein said at least one purchasing incentive comprises one of a token and a discount coupon;
said token enabling a customer to purchase said item subject to said raincheck when said item is in stock and at a price when said item was subject to said raincheck; and
said discount coupon enabling a customer to purchase said item subject to said raincheck when said item is in stock and at a discounted price.

6. The system of claim 1, wherein said at least one purchasing incentive comprises at least one of a token and a discount coupon;
said token enabling a customer to purchase said item subject to said raincheck when said item is in stock and at a price when said item was subject to said raincheck; and
said discount coupon enabling a customer to purchase said item subject to said raincheck when said item is in stock and at a price discounted from said price when said item was subject to said raincheck.

7. The system of claim 5, wherein said item is subject to said raincheck when said item is not in stock.

8. The system of claim 6, wherein said item is subject to said raincheck when said item is not in stock.

9. A process for providing in-store printing of rainchecks for purchasing incentives associated with items subject to rainchecks, comprising:
storing a plurality of purchasing incentives corresponding to a plurality of item identifiers for items subject to rainchecks via an incentive processor;
coupling said incentive processor to at least one incentive printer via an incentive processor bus;
coupling a point-of-sale (POS) controller, at least one cash register, and said incentive processor via a POS bus;
receiving at a respective cash register of said at least one cash register data defining an item identifier for an item that is subject to a raincheck;
transmitting from one of said POS controller and said respective cash register said data defining said item identifier for said item that is subject to said raincheck over said POS bus to said incentive processor;
generating at said incentive processor raincheck information including at least one purchasing incentive in response to receipt of said data defining said item identifier for said item subject to said raincheck, said plurality purchasing incentives, and said plurality of item identifiers;
transmitting from said incentive processor said raincheck information to a respective incentive printer of said at least one incentive printer over said incentive processor bus; and
printing at said respective incentive printer a raincheck including said at least one purchasing incentive in response to receipt of said raincheck information received from said incentive processor.

10. The process of claim 9, further comprising:
identifying at a retailer site said plurality of purchasing incentives corresponding to said plurality of item identifiers;
transmitting from said retailer site said plurality of purchasing incentives corresponding to said plurality of item identifiers to an incentive processing site;
receiving at said incentive processing site said plurality of purchasing incentives corresponding to said plurality of item identifiers from said retailer site; and
storing at said incentive processing site said plurality of purchasing incentives corresponding to said plurality of item identifiers via said incentive processor.

11. The process of claim 10, further comprising:
generating at one of said retailer site and said incentive processing site a raincheck list including a description of items corresponding to said plurality of item identifiers along with said plurality of item identifiers; and
receiving at said respective cash register of said at least one cash register said data defining said item identifier for an item that is subject to a raincheck based on said raincheck list.

12. The process of claim 10, further comprising:
storing a printed raincheck list comprising a list of when rainchecks were printed and item identifiers corresponding thereto via said incentive processor; and
generating at said incentive processing site a weekly report of printed rainchecks and item identifiers corresponding thereto based on said printed raincheck list.

13. The process of claim 9, wherein said at least one purchasing incentive comprises one of a token and a discount coupon;
the process further comprising one of:
enabling a customer to purchase said item subject to said raincheck when said item is in stock and at a price when said item was subject to said raincheck via said token; and
enabling a customer to purchase said item subject to said raincheck when said item is in stock and at a discounted price via said discount coupon.

14. The process of claim 9, wherein said at least one purchasing incentive comprises at least one of a token and a discount coupon;
the process further comprising one of:
enabling a customer to purchase said item subject to said raincheck when said item is in stock and at a price when said item was subject to said raincheck via said token; and
enabling a customer to purchase said item subject to said raincheck when said item is in stock and at a discounted price via said discount coupon.

15. The process of claim 13, further comprising subjecting said item to said raincheck when said item is not in stock.

16. The process of claim 14, further comprising subjecting said item to said raincheck when said item is not in stock.

17. A computer program product comprising a computer storage medium having a computer program embedded in said computer storage medium for causing a computer to provide in-store printing of rainchecks for purchasing incentives associated with items subject to rainchecks, said computer program performing the steps of:
storing a plurality of purchasing incentives corresponding to a plurality of item identifiers for items subject to rainchecks via an incentive processor;
coupling said incentive processor to at least one incentive printer via an incentive processor bus;
coupling a point-of-sale (POS) controller, at least one cash register, and said incentive processor via a POS bus;
receiving at a respective cash register of said at least one cash register data defining an item identifier for an item that is subject to a raincheck;
transmitting from one of said POS controller and said respective cash register said data defining said item identifier for said item that is subject to said raincheck over said POS bus to said incentive processor;
generating at said incentive processor raincheck information including at least one purchasing incentive in response to receipt of said data defining said item identifier for said item subject to said raincheck, said plurality purchasing incentives, and said plurality of item identifiers;
transmitting from said incentive processor said raincheck information to a respective incentive printer of said at least one incentive printer over said incentive processor bus; and
printing at said respective incentive printer a raincheck including said at least one purchasing incentive in response to receipt of said raincheck information received from said incentive processor.

18. The computer program of claim 17, further performing the steps of:
identifying at a retailer site said plurality of purchasing incentives corresponding to said plurality of item identifiers;
transmitting from said retailer site said plurality of purchasing incentives corresponding to said plurality of item identifiers to an incentive processing site;
receiving at said incentive processing site said plurality of purchasing incentives corresponding to said plurality of item identifiers from said retailer site; and
storing at said incentive processing site said plurality of purchasing incentives corresponding to said plurality of item identifiers via said incentive processor.

19. The computer program of claim 18, further performing the steps of:
generating at one of said retailer site and said incentive processing site a raincheck list including a description of items corresponding to said plurality of item identifiers along with said plurality of item identifiers; and
receiving at said respective cash register of said at least one cash register said data defining said item identifier for an item that is subject to a raincheck based on said raincheck list.

20. The computer program of claim 18, further performing the steps of:
storing a printed raincheck list comprising a list of when rainchecks were printed and item identifiers corresponding thereto via said incentive processor; and
generating at said incentive processing site a weekly report of printed rainchecks and item identifiers corresponding thereto based on said printed raincheck list.

21. The computer program of claim 17, wherein said at least one purchasing incentive comprises one of a token and a discount coupon;
the computer program, further performing one of the steps of:
enabling a customer to purchase said item subject to said raincheck when said item is in stock and at a price when said item was subject to said raincheck via said token; and
enabling a customer to purchase said item subject to said raincheck when said item is in stock and at a discounted price via said discount coupon.

22. The computer program of claim 17, wherein said at least one purchasing incentive comprises at least one of a token and a discount coupon;
the computer program, further performing one of the steps of:
enabling a customer to purchase said item subject to said raincheck when said item is in stock and at a price when said item was subject to said raincheck via said token; and
enabling a customer to purchase said item subject to said raincheck when said item is in stock and at a discounted price via said discount coupon.

23. The computer program of claim 21, performing the step of subjecting said item to said raincheck when said item is not in stock.

24. The computer program of claim 22, performing the step of subjecting said item to said raincheck when said item is not in stock.

25. A system for providing in-store printing of rainchecks for purchasing incentives associated with items subject to rainchecks, comprising:
means for storing a plurality of purchasing incentives corresponding to a plurality of item identifiers for items subject to rainchecks;
means for coupling an incentive processing means to at least one incentive printing means;
means for coupling a point-of-sale (POS) controller means, at least one cash register means, and said incentive processing means;
means for receiving at a respective cash register means of said at least one cash register means data defining an item identifier for an item that is subject to a raincheck;
means for transmitting from one of said POS controller means and said respective cash register means said data defining said item identifier for said item that is subject to said raincheck to said incentive processing means;
means for generating raincheck information including at least one purchasing incentive in response to receipt of said data defining said item identifier for said item subject to said raincheck, said plurality purchasing incentives, and said plurality of item identifiers;
means for transmitting said raincheck information to a respective incentive printing means of said at least one incentive printing means; and
means for printing at said respective incentive printing means a raincheck including said at least one purchasing incentive in response to receipt of said raincheck information.

26. The system of claim 25, further comprising:
means for identifying at a retailer site said plurality of purchasing incentives corresponding to said plurality of item identifiers;
means for transmitting from said retailer site said plurality of purchasing incentives corresponding to said plurality of item identifiers to an incentive processing site;
means for receiving at said incentive processing site said plurality of purchasing incentives corresponding to said plurality of item identifiers from said retailer site; and
means for storing at said incentive processing site said plurality of purchasing incentives corresponding to said plurality of item identifiers.

27. The system of claim 26, further comprising:
means for generating at one of said retailer site and said incentive processing site a raincheck list including a description of items corresponding to said plurality of item identifiers along with said plurality of item identifiers; and
means for receiving at said respective cash register means of said at least one cash register means said data defining said item identifier for an item that is subject to a raincheck based on said raincheck list.

28. The system of claim 26, further comprising:
means for storing a printed raincheck list comprising a list of when rainchecks were printed and item identifiers corresponding thereto; and
means for generating at said incentive processing site a weekly report of printed rainchecks and item identifiers corresponding thereto based on said printed raincheck list.

29. The system of claim 25, wherein said at least one purchasing incentive comprises one of a token and a discount coupon;
the system further comprising one of:
means for enabling a customer to purchase said item subject to said raincheck when said item is in stock and at a price when said item was subject to said raincheck via said token; and
means for enabling a customer to purchase said item subject to said raincheck when said item is in stock and at a discounted price via said discount coupon.

30. The system of claim 25, wherein said at least one purchasing incentive comprises at least one of a token and a discount coupon;
the system further comprising one of:
means for enabling a customer to purchase said item subject to said raincheck when said item is in stock and at a price when said item was subject to said raincheck via said token; and
means for enabling a customer to purchase said item subject to said raincheck when said item is in stock and at a discounted price via said discount coupon.

31. The system of claim 29, further comprising means for subjecting said item to said raincheck when said item is not in stock.

32. The system of claim 30, further comprising means for subjecting said item to said raincheck when said item is not in stock.
